(19) United States
(12) Patent Application Publication
(10) Pub. No.: US 2021/0374614 A1
(43) Pub. Date: Dec. 2, 2021

(54) ACTIVE LEARNING ANNOTATION SYSTEM THAT DOES NOT REQUIRE HISTORICAL DATA

(71) Applicant: Feedzai - Consultadoria e Inovação Tecnológica, S.A., Coimbra (PT)

(72) Inventors: Marco Oliveira Pena Sampaio, Vila Nova de Gaia (PT); João Tiago Barriga Negra Ascensão, Lisbon (PT); Pedro Gustavo Santos Rodrigues Bizarro, Lisbon (PT); Ricardo Jorge Dias Barata, Porto (PT); Miguel Lobo Pinto Leite, Caminha (PT); Ricardo Jorge da Graça Pacheco, Agualva-Cacém (PT)

(21) Appl. No.: 17/331,501

(22) Filed: May 26, 2021

Related U.S. Application Data
(60) Provisional application No. 63/031,303, filed on May 28, 2020.

(30) Foreign Application Priority Data
May 19, 2021 (EP) 21174834.8
May 19, 2021 (PT) 117242

(51) Int. Cl. G06N 20/00; G06F 16/28

(52) U.S. Cl. CPC G06N 20/00; G06F 16/285

(57) ABSTRACT

In various embodiments, a process for providing an active learning annotation system that does not require historical data includes receiving a stream of unlabeled data, identifying a portion of the unlabeled data to label without access to label information, and receiving a labeled version of the identified portion of the unlabeled data and storing the labeled version as labeled data. The process includes analyzing the labeled version and at least a portion of the received unlabeled data that has not been labeled to identify an additional portion of the unlabeled data to label and store in the labeled data including by applying at least one warm up policy.

### CROSS REFERENCE TO OTHER APPLICATIONS

This application claims priority to U.S. Provisional Patent Application No. 63/031,303 entitled ACTIVE LEARNING ANNOTATION SYSTEM TO TRAIN A MACHINE LEARNING MODEL WITH NO HISTORICAL DATA filed May 28, 2020 which is incorporated herein by reference for all purposes.

This application claims priority to Portugal Provisional Patent Application No. 117242 entitled ACTIVE LEARNING ANNOTATION SYSTEM THAT DOES NOT REQUIRE HISTORICAL DATA filed May 19, 2021 which is incorporated herein by reference for all purposes.

This application claims priority to European Patent Application No. 21174834.8 entitled ACTIVE LEARNING ANNOTATION SYSTEM THAT DOES NOT REQUIRE HISTORICAL DATA filed May 19, 2021 which is incorporated herein by reference for all purposes.

### BACKGROUND OF THE INVENTION

Supervised Machine Learning (ML) models are widely used, especially in electronic services, where vast amounts of data are generated daily in domains as diverse as financial services, entertainment, or consumer goods. ML models are often central in decisions that enhance system efficiency, user experience, safety, among other things. The performance of ML models relies heavily on the quality of the data they are trained on, specifically, suitably labeled data in supervised settings. However, labeled data is typically expensive to collect. For example, they often require human annotation.

Because there is a limited budget of human annotations that can be performed, for large datasets, a subset of the data is forwarded for human annotations. Active Learning (AL) is a framework that attempts to select the smallest/best subset of data to be labeled in order to train a high performance ML model. Conventional AL systems typically require at least some historical data to perform well. However, historical data is not always available.

### BRIEF DESCRIPTION OF THE DRAWINGS

Various embodiments of the invention are disclosed in the following detailed description and the accompanying drawings.

FIG. 1 illustrates an example of a data stream processed according to the disclosed techniques.

FIG. 2 is a flow diagram illustrating an embodiment of a process for providing an active learning annotation system that does not require historical data.

FIG. 3 is a block diagram illustrating an embodiment of an active learning annotation system that does not require historical data.

FIG. 4 is a block diagram illustrating an embodiment of an active learning annotation system that does not require historical data for training a machine learning model.

FIG. 5 is a functional diagram illustrating a programmed computer system for providing an active learning annotation system that does not require historical data in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The collection of labeled data to train Machine Learning (ML) models is often an expensive task that requires a careful selection of small and informative samples of instances to label. Techniques of the present disclosure provide an AL-based annotation system that can be used to process data streams, e.g., in real-time, to quickly train a high performance model. The disclosed techniques are capable of batch and stream processing (real-time processing of events as they are received) and do not require historical data, although they are also compatible with historical data or in offline batch jobs.

Embodiments of the present disclosure provide a ML system based on AL that integrates the selection and annotation of small samples of unlabeled data, as well as continuing ML model training and evaluation. In various embodiments, the disclosed techniques provide an end-to-end automated machine learning (AutoML) solution that minimizes labeled data requirements and supports annotation-in-the-loop, human, or otherwise. Due to its modular nature, the disclosed system supports pluggable feature engineering and selection, sampling policies, annotators, and deploying criteria, of which pluggable feature engineering and selection is not a requirement The system can be extended with complementary functionality (e.g., architecture search, hyper-parameter tuning, pre-trained models, model selection, distillation, or A/B testing).

In various embodiments, a three stage AL sequence includes: starting with sampling based on the unlabeled data (unsupervised) or randomly, followed by an Outlier Discriminative AL (ODAL) method (whose goal is to minimize differences in representativeness of the unlabeled data in the labeled data), and a supervised AL policy that also uses information on the collected labels to guide the sampling.

In various embodiments, an online evaluation method evaluates model performance. Various deploying criteria may be used, for example, performing stabilizing predictions based on model scores distributions.

As further described herein, features supported by the disclosed techniques include:
Real-time online streaming data or batch data.
An arbitrary sequence of AL policies and combinations of policies, with time dependent criteria to switch policy. For example, a three stage policy includes, after a first small random batch of data is labeled, using an outlier detection based discriminative active learning method, followed by an uncertainty sampling policy.
Any type of annotator, including a team of annotators that can be human (or any system interface to human annotators), as well as any automatic annotation system, including annotation from a system that collects external information from a service or even from a data source of labels.
Online model training (including cross validation), model calibration and performance estimation.
Online verification of stopping criteria metrics to diagnose if the ML model has stabilized and is ready for deployment.

The system can also be used for sampling purposes in cases where labels are available but a small representative sample of data is desired for efficiency reasons (e.g. to limit hardware usage costs). In those cases the annotation is simulated.

Furthermore, policy, data stream, team of annotators and ML model, in addition to having a natural interdependency through the AL loop, can depend on one another in more general ways. For example, the policy may adapt according to the available labeling resources to query for more or less instances of some type, or may use the ML model at the current iteration to prioritize instances that will help improve the ML model.

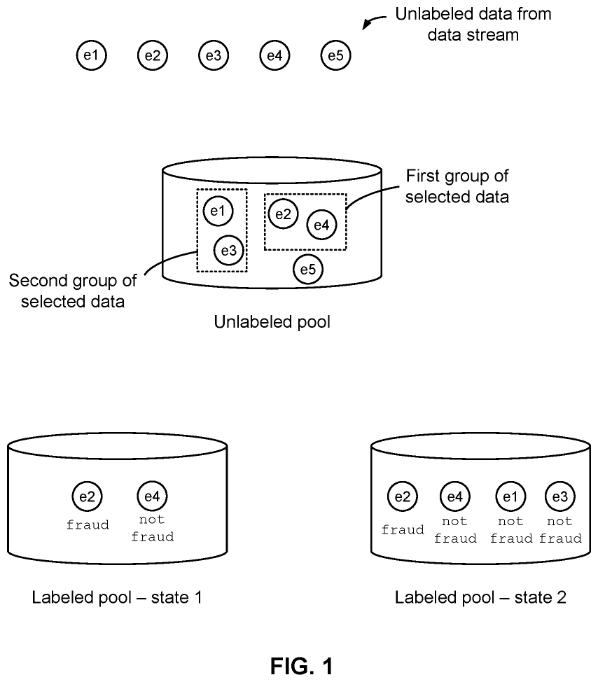

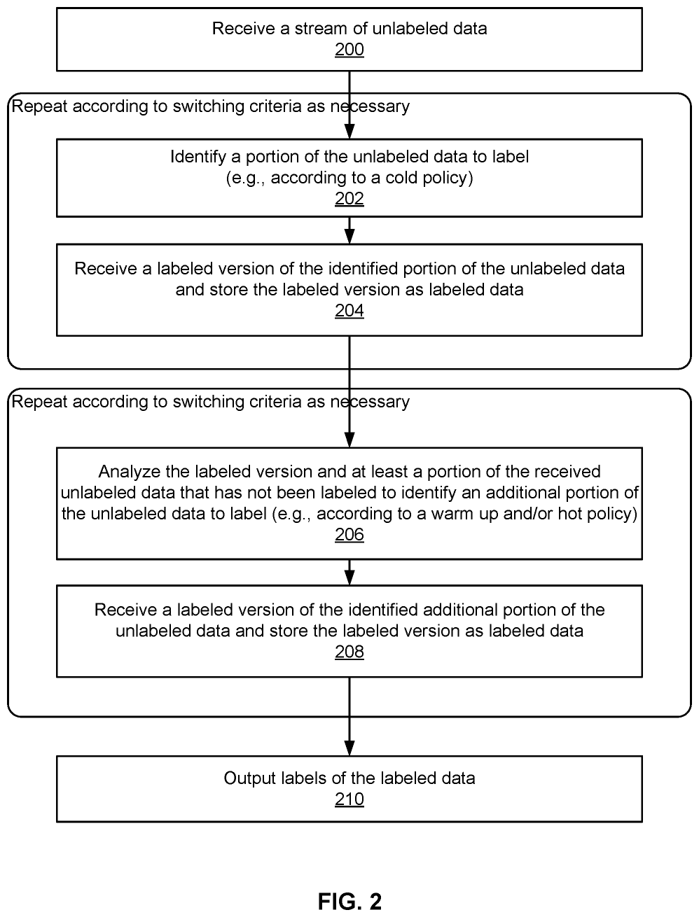

FIG. 1 illustrates an example of a data stream processed according to the disclosed techniques. The data stream includes five events, e1 to e5, which are each unlabeled. The data stream is processed according to the disclosed techniques (e.g., the process of FIG. 2) to label at least some of the data. The labeled data can then be used to perform supervised machine learning.

When the system starts up for the first time, some of the unlabeled data in the data stream are selected to be labeled. In this example, the portion of the unlabeled data to label include event e2 and event e4, collectively referred to as the first group of selected data within the dashed box as shown. The selection of the first group can be made by using an AL policy based on an unsupervised learning method (a cold policy), as further described herein, or randomly (random AL policy). The unlabeled data is then labeled by an annotator, e.g., a human analyst, or another labeling service. The unlabeled data is now labeled and is stored in a pool of labeled data as shown in state 1 of the labeled pool. In this example, event e2 is labeled as “fraud” and event e4 is labeled as “not fraud.”

Next, further unlabeled events are selected to be labeled. The selection can now be done with an AL policy (a warm up policy) that uses information from both the already labeled (e2 and e4) and unlabeled (e1, e3 and e5) events. Referring to the unlabeled pool, events e1 and e3 are identified to be labeled. Events e1 and e3 are collectively referred to as the second group of selected data within the dashed box as shown. These events can be labeled in the same way that events e2 and e4 were labeled, e.g., by a human analyst. Upon labeling, they too are added to the labeled pool (state 2). In this example, events el and e3 are each labeled as “not fraud.” Events may be further processed using other policies such as a hot policy (a supervised AL policy that uses the collected labeled data including the label values). With respect to the cold, warm up, and hot policies, which policy is applied can be selected according to a switching criteria as further described herein.

Any number of iterations can be performed until a desired number or proportion of labeled data is obtained, or according to any other stopping condition. The labeled data can be used for a variety of purposes including to perform supervised machine learning, in any intermediate iteration and not necessarily in all iterations.

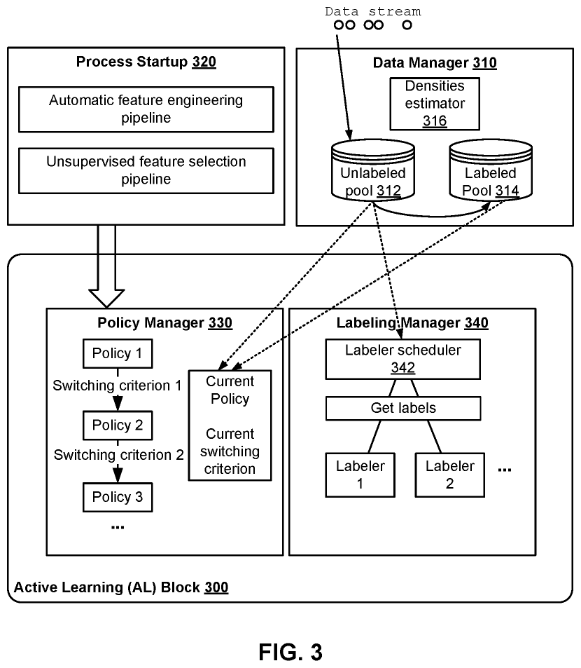

FIG. 2 is a flow diagram illustrating an embodiment of a process for providing an active learning annotation system that does not require historical data. The process iteratively selects batches of data for labeling so that a ML model can be trained and quickly improved on each new iteration, while making an efficient use of labeling resources. The selected batches can be small (e.g., below a threshold size such as 10 events or as few as 1 event). The process may be performed by a system such as the one shown in FIG. 3.

In the example shown, the process begins by receiving a stream of unlabeled data (200). In various embodiments, the unlabeled data is placed into an unlabeled pool. The process can start with empty data pools, meaning no historical data is required so that when a first event in the stream of unlabeled data is received, no historical data is available.

Prior to performing the rest of the process, an optional preprocessing step may be performed. The preprocessing step refers to an optional step to pre-process raw data. The pre-processing can be performed once at startup. Unlike conventional processes, the process shown in FIG. 2 does not require any previous knowledge, so it is prepared to support various forms of preprocessing of the raw data stored in the data pools. In some use cases such preprocessing may not be necessary if the data fields received are already usable. An example would be if the ML model or the AL policy can learn the features they need from the raw fields. Deep learning models are an example that typically need very little feature engineering and can learn useful data representations as part of the training process.

Domain Knowledge Feature Engineering refers to a feature engineering plan that transforms raw fields into numerical features, categorical features, or the like. This can be based on suggestions by experts with domain knowledge or it may be transferred from a previous historical data source with a similar schema containing at least some fields with the same semantic meaning (examples of such fields in credit card fraud detection include a numerical monetary amount or a string identifying a customer).

Domain Knowledge Feature Engineering refers to a feature engineering plan that transforms raw fields into numerical features, categorical features, or the like. This can be based on suggestions by experts with domain knowledge or it may be transferred from a previous historical data source with the same schema.

Automatic Feature Engineering refers to automatically generating a feature engineering plan based only on the semantics of the raw fields. For example, Feedzai's AutoML tool is capable of doing this. To configure the system, a semantic mapping file is used (no other information is required) to tag the raw fields (specifying, e.g., grouping entities, numerical fields, or the semantics of fields to be used in predefined types of feature engineering operations), together with a specification of window durations to compute profile feature aggregations. This method may be iterated several times, to repeat the feature engineering operations (using features generated in intermediate steps).

Unsupervised Feature Selection refers to techniques such as domain knowledge (human-provided suggestion of the most relevant features), pairwise correlations, or dimensional reduction. Supporting unsupervised feature selection may be especially attractive when an automatic feature engineering plan is generated, which may produce several hundreds of automatic features. In experiments, the data science performance of some ML models was found to degrade if too many noisy or redundant features are provided. Furthermore, from a system perspective, computing more features than necessary is computationally wasteful.

Pairwise correlations refers to iteratively removing features by computing pairwise correlations on a training set. The process starts with the most correlated pair and removes one of the features. Then it continues iteratively either until a (small enough) threshold value of pairwise correlation is attained or a pre-specified number of features is left. Though this process only directly exploits bivariate correlations, it offers an advantage that it removes features in the original feature space, so the feature plan can be reduced to a smaller size while keeping features that are more human interpretable.

Dimensional reduction refers to mapping the feature space to a lower dimensional space via training. One advantage is providing fewer features for the ML model but may require the computation of the original features. For example, Principal Component Analysis (PCA) can be applied to reduce the dimensionality of the feature space obtained through automatic feature engineering. In various embodiments, a sample of unlabeled data, which may be used by Pairwise correlation or Dimensional reduction can be collected through an initial waiting period (e.g., one day).

The process identifies a portion of the unlabeled data to label without requiring access to label information (202). The unlabeled data can be identified in a variety of ways such as by performing unsupervised learning or random sampling. Unsupervised learning refers to learning a representation of the available unlabeled data that can be used to rank data instances for selection. Random sampling randomly selects unlabeled data to be labeled. No existing label information is used or required in order to identify data to be labeled.

The process receives a labeled version of the identified portion of the unlabeled data and stores the labeled version as labeled data (204). The label can be received from a human analyst or other system that determines a label for the unlabeled data.

The data can be selected to be labeled by training one or more policies in a given sequence using labeled and/or unlabeled data and applying the one or more policies to a sample of unlabeled data instances to select one or more instances to label and send them to a labeling system to collect the label. The sample of unlabeled data instances may include all unlabeled data or a subset of all unlabeled data. In various embodiments, a sequence of policies and the determination to switch to a next policy in the sequence is based on a switching criterion, as further described herein. This is represented by “repeat according to switching criteria as necessary,” meaning 202 and 204 can be repeated until one or more switching criteria is met.

The process analyzes the labeled version and at least a portion of the received unlabeled data that has not been labeled to identify an additional portion of the unlabeled data to label and store in the labeled data (206). Unlike the unsupervised policy of 202, the policy of 206 is a warm up policy that is discriminative between the labeled and unlabeled pool (in a first iteration of 206) or a hot policy (in subsequent iterations of 206). The cold policy (202) and warm up policy can be followed by any other standard AL policy, such as a supervised (hot) policy or any sequence of AL policies.

The sequence of policies can be adapted to imbalanced datasets where the warmup is outlier discriminative active learning (ODAL) as further described herein. The following sequence of policies is applied: random or other unsupervised initialization (202), ODAL warmup (206), and supervised policy, for example with various possible uncertainty measures (206). In other words, a cold policy and a warm up policy can be followed by other policies such as further warm up policies or hot policies.

The process receives a labeled version of the identified additional portion of the unlabeled data and stores the labeled version as labeled data (208). The label can be received from a human analyst or other system that determines a label for the unlabeled data.

The data can be selected to be labeled by training one or more policies in a given sequence using labeled and/or unlabeled data and applying the one or more policies to a sample of unlabeled data instances to select one or more instances to label and send them to a labeling system to collect the label. In various embodiments, a sequence of policies and the determination to switch to a next policy in the sequence is based on a switching criterion, as further described herein. This is represented by “repeat according to switching criteria as necessary,” meaning 206 and 208 can be repeated until one or more switching criteria is met.

The process outputs labels of the labeled data (210). The labels can be used for a variety of purposes such as updating a rules system or performing supervised machine learning training using the labeled data. ML model performance metrics can be estimated online with the available labels, e.g., including using online cross validation to tune model parameters. In various embodiments, a ML model is trained using all of the labeled data. The ML model can be determined to be ready for deployment using a deployment criterion. If the ML model is not ready, then the process can be repeated to further train/improve the ML model. Labels may be available prior to completion of the process of FIG. 2. For example, in some embodiments, an ML model is trained using available labels while the process of FIG. 2 is being performed.

FIG. 3 is a block diagram illustrating an embodiment of an active learning annotation system that does not require no historical data. The system includes Data Manager 310, Process Startup Module 320, and Active Learning (AL) Block 300.

Data Manager 310 is configured to manage an incoming data stream, and includes an unlabeled data storage 312, a labeled data storage 314, and a densities estimation module 316 to estimate data distributions in the data pools or their ratios. The data stream collects/contains events in real time, which get stored in the Unlabeled pool data storage 312 (which grows in size as time passes). The Labeled pool data storage 314 stores labeled events. In some embodiments, the Labeled pool 314 and/or the Unlabeled pool 312 starts empty. In some embodiments, the Unlabeled pool 312 starts already populated and may or may not receive new events, and the labeled pool starts with a small number of labeled events.

The Process Startup module 320 is configured to perform automatic feature engineering and feature filtering by pre-processing raw data when the system starts for the first time. For example, it can (optionally) contain a preprocessing pipeline responsible for transforming the raw data to enrich it with further features to be used for machine learning (configurable, e.g., through domain knowledge), or it can (also optionally) produce an automatic feature preprocessing pipeline to enrich the raw fields. For example, the Process Startup Module prepares an automatic feature engineering plan based on the semantics of the raw fields provided in the data schema. Then, it can also fit an unsupervised feature selection method using an initially collected batch of unlabeled data. The feature selection pipeline can be periodically updated by re-fitting to the latest available data, though it is presented only in the Process Startup block 320 in the diagram of FIG. 3 for simplicity.

The AL Block 300 is configured to iteratively perform label collection and model training. The various components included in the AL Block communicate with the Data Manager to access or manipulate the data (where the preprocessing pipeline, if present, is applied to raw data). In this example, the AL Block includes a Policy Manager 330, and Labeling Manager 340.

Policy Manager 330 is configured to use a sequence of AL policies to select queries to be labeled. The system supports an arbitrary sequence of policies chained together with switching criteria that may depend on the state of any other component of the system. This is represented by the sequence of policies Policy 1, Policy 2, Policy 3, . . . as shown. The active policy is represented by the “Current Policy-Switching Criteria” pair as shown. In the diagram, for simplicity, the minimal dependence on the data is indicated by the dotted line arrows fetching the unlabeled and labeled data, for the “Current Policy-Switching Criteria” pair, from the Data Manager.

Labeler Manager 340 is configured to distribute queries among one or more labelers. The labeler(s) may be human analysts and/or automatic labeling systems. The labeler manager processes the queries selected by the current policy for labeling. The Labeler Manager includes a Labeler Scheduler 342 configured to fetch the unlabeled data (dotted line arrow) corresponding to the queries and distribute them through a team of labelers (Labeler 1, Labeler 2, . . . ). After the labeler(s) provide feedback, the labels are sent back (dash dotted line arrow) to the Data Manager, which moves the corresponding unlabeled events to the labeled pool with the labels (solid line arrow).

Unlike conventional systems, the disclosed system supports startup with no previous historical data and minimal human intervention in configuring it. In various embodiments, the configuration steps involve setting one or more of the following specifications (some of which are further described herein):
Input data source (either an unlabeled static data source or a data stream is connected to the system),
A density estimation method,
Feature Engineering Plan (provided or automatic),
The sequence of AL policies with respective query batch sizes, and switching criteria,
The labeler scheduler with an interface to the labelers. For example, a simple scheduler will distribute the queries uniformly at random among labelers. As described herein, the team of labelers may be a team of human analysts or any other feedback system. Examples of labelers include human operators connected to the system via a computer interface, a data source of labels, an automatic labeler that fetches information from another system to compute the label.
An online model training and evaluation specification including one or more of the following:
   A data splitter specification, e.g., including the number of splits and fraction of data to use in each split.
   A ML model specification, to be trained on the labeled data.
   A set of performance metrics to be computed for each evaluation.
A deploying criterion specification

The disclosed techniques find applications in a variety of settings. The examples discussed herein typically refer to systems that are responsible for detecting illicit activities, (e.g., transaction fraud in online payments or money laundering transactions), but this is merely exemplary and not intended to be limiting. The disclosed techniques are well suited for a streaming environment with transactions collected in real-time, among other things. AL is particularly useful in the fraud/illicit activities scenario where there is often a considerable delay between the fraudulent event and the collection of the true label (e.g., through client complaints or reports from financial institutions), unless a human analyst is consulted.

In various embodiments, the deploying criterion is based on stabilization of metrics that are independent of scoring rules such as scores distributions, alert rates, AUC or estimates of expected performance.

The deployment (stopping) criterion method that seems to perform better is the SP method. An advantage of such a method is that it only relies on the unlabeled pool which does not suffer from the low statistic problem of the labeled pool. Furthermore, since it compares the agreement of a sequence of models with the agreement by random chance, it is possible to define a stopping threshold criterion that is independent of the dataset. However, conventional techniques also rely on a scoring rule, which implies choosing a threshold. This could be done on the labeled pool or via an expected threshold estimate using the unlabeled pool (but again the expectation uses the model scores as class label probabilities).

Another possibility that does not need a scoring rule, would be to adapt the SP method to measure disagreement between model scores distributions on the unlabeled pool, and stop when the level of agreement is within an expected probability by random chance. The Kolmogorov-Smirnov, Kuiper and Anderson-Darling test statistics are examples of suitable distance measures with well known statistical tests.

Other useful simple quantities that can be monitored to detect a stabilizing gradient that can depend on the labeled pool are:
The model alert rate (or any other rate) based on a threshold either on the labeled or unlabeled pool,
Log-loss, ROC curve AUC or partial AUC or their expectations under labeling by the model score.

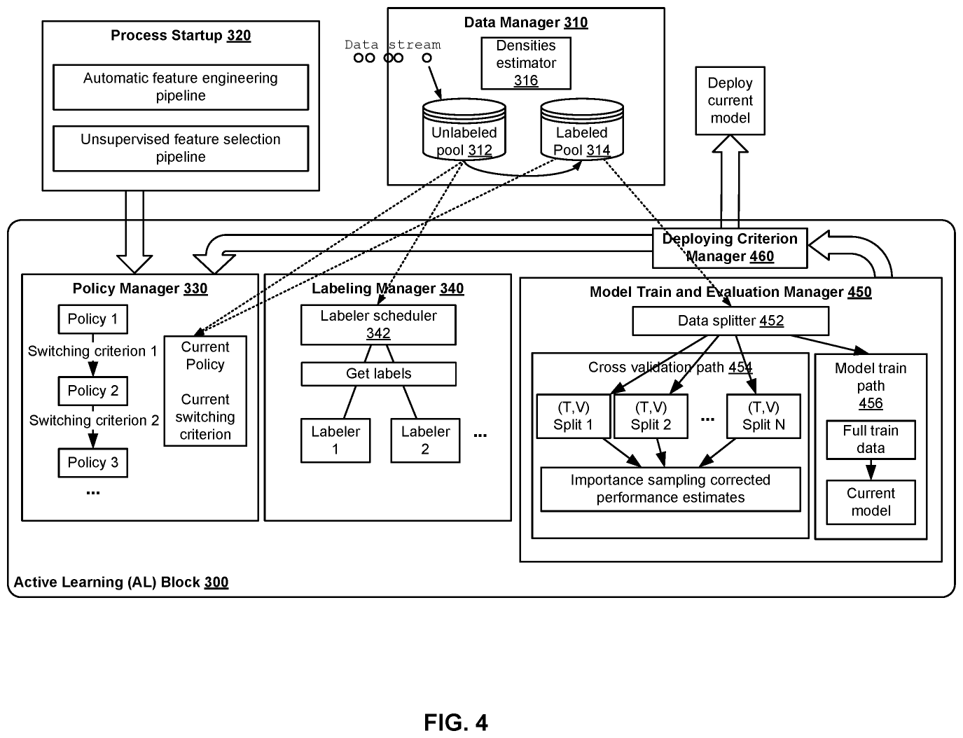

FIG. 4 is a block diagram illustrating an embodiment of an active learning annotation system that does not require historical data for training a machine learning model. The labels determined by the AL block can be used to perform supervised machine learning training. Each of the components are like their counterparts in FIG. 3 unless otherwise described herein. Unlike the system shown in FIG. 3, the AL block 300 also includes a Model Train and Evaluation Manager 450, and a Deploying Criterion Manager 460.

Model Train and Evaluation Manager 450 is configured to train one or more ML models using the labeled data and perform online evaluations to estimate model performance. Manager 450 uses the available labeled data (fetched as represented by the dashed arrow) to train and evaluate a ML model. In this example there are the following paths: i) an optional evaluation path (Cross Validation Path 454) where the data may be split by Data Splitter 452 into one or more Train-Validation (T,V) pairs to train and evaluate the ML model and produce estimates of its performance, and ii) a Model Train Path 456 that fits the model with all the labeled data for deployment.

Deploying Criterion Manager 460 is configured to decide when the model is ready for deployment. For example, a model may be considered ready for deployment when an estimate for a supervised performance metric does not change by a prespecified tolerance level, when the model is stable, or any other metrics. Using the example of model stability, manager 460 checks if the predictions of the ML model and/or its performance have stabilized so that the model is ready for deployment. If the models are not considered stable, the AL block will continue processing (which is why this is sometimes referred to as an AL loop). If the models are considered stable, the model is deployed and the AL loop may or may not continue collecting more labels to improve the model further.

Some of these components shown in FIG. 3 or FIG. 4 may operate asynchronously. For example: i) there may be accumulated queries in the Labeling Manager 340 while the Policy Manager 330 may already be running the next iteration with the additional labeled data that was provided in the meantime, ii) similarly the Model Train Manager 450 may be training a model while the Policy Manager 330 may be already exploiting the newest labels to suggest further queries to the Labeling Manager 340.

Several AL policies will now be discussed. They are merely exemplary and not intended to be limiting as the system can support an arbitrary sequence of policies, batch sizes and switching criteria to switch between policies. As discussed with respect to Policy Manager 330 of FIG. 3, in various embodiments, the system starts the selection of events with the first policy for the first batch size. This is repeated, for the same policy, on each AL loop iteration, until a switching criterion is triggered. Then the next policy and next batch size become active. This switching continues until the last policy becomes active.

In various embodiments, policies may be applied in the following hierarchy/sequence: Cold, Warm up, and Hot. A Cold Policy is applied, and switched to a Warm up policy after a given number of labels has been collected, as specified by the corresponding switching criterion. This typically collects a small sample of labels. The small sample is of a size sufficient for the next policy to be applied, e.g. if the next policy has to fit internal parameters and needs a minimum amount of data to perform such fitting operations, which can be, for some policies, as small as a single instance. A Warm up Policy uses both the unlabeled pool and labeled pool distributions (regardless of the label values). The system switches to the next policy after a minimum number of labels is collected, as specified by the switching criterion, to represent sufficiently well the distribution of the target variable for the next policy to be able to act. An example is binary classification for fraud detection, where a common criterion would be to require that at least one fraud event is detected. A Hot Policy uses the available labels and collects new labels with a goal of improving the ML model's performance, which is unlike the Cold and Warmup policies, whose goal is to represent well the unlabeled pool regardless of the labels.

Some examples of Cold Policies include:
Random: Each batch of queries is obtained by randomly selecting instances from an unlabeled pool, without replacement.
Isolation Forest: An isolation forest is trained on an unlabeled pool and then the isolation score is used to rank the unlabeled instances from most outlier-like to most inlier-like. The top instances with the highest outlier score are selected for querying.
Elliptic envelope: a computationally lighter outlier detection method where a multivariate Gaussian is fit to the unlabeled pool and then used to rank the transactions according to the Mahalanobis distance (the multidimensional equivalent of the z-score for a univariate Gaussian). Instances with a larger distance are given higher priority to be selected.

In various embodiments, a Warm up Policy includes Outlier Discriminative Active Learning (ODAL), where an outlier detection model is trained on the labeled pool, and then used to score the unlabeled pool to find the greatest outliers relative to the labeled pool. The selected queries are then those with the highest outlier score. In typical AL scenarios the labeled pool is much smaller than the unlabeled pool. Therefore this provides a policy that is computationally much lighter than conventional methods, because it can be trained on the labeled pool only, in contrast with regular discriminative AL where the (large) unlabeled pool is also necessary to train the discriminator.

Some examples of Hot Policies include uncertainty sampling, query by committee, expected model change, expected variance reduction and epistemic uncertainty. Each of these examples will now be discussed.

Uncertainty Sampling is a Hot Policy in which the most common uncertainty criterion includes selecting instances with the highest expected entropy of the probability distribution of the classes. This principle assumes that the scores produced by the ML model provide well calibrated probabilities. In general, for many algorithms, this is not the case and the problem becomes more serious for problems with a high class imbalance. In the latter the distribution of scores can be very often highly skewed towards the high frequency class(es) and if sampling is used (as is the case in AL) the probabilities may be further biased.

One approach to improve this issue is to perform scores calibration, using methods such as Isotonic regression or Platt scaling. This means that the uncertainty criterion can remain as it is, but the entropy is now calculated with the calibrated scores. In various embodiments, this method uses/maintains a separate calibration set or cross validation.

A second uncertainty sampling approach, for binary classification, that does not rely on calibration uses the fact that the score of most ML algorithms is a monotonic function of the class probability. Thus instances with higher scores are expected to have a higher probability of being of positive class. Given a sample of data, the classification boundary for that distribution of data can be equivalently characterized by a score quantile, i.e., a position in the sorted set of scores. The quantile of the classification boundary, for a perfect clairvoyant classifier that knows the labels would be equal to the negative class rate (or, equivalently, one minus the positive class rate). Thus, an alternative uncertainty criterion is one that is independent of scores calibration where the uncertainty boundary is at the quantile given by the estimated negative class rate.

A third approach is based on the characteristic that for highly imbalanced problems at the early stages of AL, uncertainty sampling is much more likely to collect negative class instances (since they dominate the data distribution). Thus, an alternative uncertainty criterion is one where the selected transactions are those with a highest score, to maximize the chance of collecting positive class labels (to be able to discriminate the classes and less likely to be sampled due to the imbalance).

Query By Committee is a Hot Policy where the decisions of several ML models (the committee) are combined to decide which events to select for labeling. The standard criterion is to choose the events for which the models disagree the most on the predicted label. In various embodiments this may be sensitive to the calibration of the scores output by each model in the committee. An alternative measure of disagreement among the models in the committee that is insensitive to whether or not the scores output by each model are correctly calibrated as probabilities is now presented. This can be important if the committee contains a mixture of models with and without a probabilistic outcome. For each model in the committee, the unlabeled pool instances are ranked by descending model score, and the average pairwise absolute difference of ranks between any two models is computed. Instances on which the models disagree are expected to have very different rankings across models, so the events with larger average pairwise absolute difference of ranks are prioritized for labeling.

Expected Model Change is a Hot Policy that is simpler in comparison to the other Hot Policy examples described herein. First a gradient-based classifier is trained on the labeled data pool. Then, for each unlabeled instance, the contribution of the instance to the gradient of the loss function is computed for each possible label assignment. Next a sum is computed of the L2 norm of the two possible gradients, for each of the assignments, weighted by the model score. This corresponds to the expected gradient norm under the class label probabilities obtained from the model scores for the given instance (assuming that the model parameters are at an optimum of the model's loss function for the current labeled pool). Finally, the unlabeled pool instances are ranked in descending order according to this quantity, so that instances with larger expected gradient are prioritized.

Expected Variance Reduction and Epistemic Uncertainty are Hot Policies that attempt to estimate the variance of the model predictions. Epistemic uncertainty is the reducible part of the total uncertainty. It is composed of the model uncertainty (or bias), which is due to the restricted choice of hypothesis space when fixing a type of model, plus the approximation uncertainty (variance), which is reducible by collecting more data. The remaining uncertainty (also known as aleatoric) is intrinsic to the data generating process and typically cannot be eliminated.

The uncertainty sampling criterion that uses the entropy of the model scores is the total uncertainty criterion (epistemic plus aleatoric uncertainty). The epistemic uncertainty, being the difference between the total and aleatoric uncertainty, may give a better measure of uncertainty for AL, because it is only sensitive to the reducible components. Although the epistemic uncertainty still contains the uncertainty from the bias (the choice of type of model), it turns out to be more tractable, in some cases, than variance estimates. One shortcoming of typical expected variance reduction methods is that they usually rely on analytic expressions for variance estimates that hold for differentiable models. In various embodiments, the disclosed techniques use a random forest model, which is non-differentiable but offers a convenient way of controlling regularization (by using a large number of shallow trees) while providing good generalization (this can be especially important to train on small data samples such as the labeled pool). The epistemic uncertainty for random forests can be estimated by subtracting the aleatoric uncertainty (average over each one of the entropies of each tree's model scores) from the total uncertainty (the entropy of the model scores produced by averaging the scores over all of the trees in the ensemble).

Combining policies could potentially provide improvements by collecting a mixture of samples in each AL loop batch according to different policy criteria. Densities estimator 316 can be used to combine policies by determining information about the ratio of labeled data to unlabeled data. An effective way of encouraging the AL policy to sample from dense regions of the parameter space without removing the Hot Policy AL criterion is to deform it. One such method is an information-density framework. In this method the density based deformation factor is a measure of similarity between the given instance and the input distribution, so that instances that are more representative of the distribution are prioritized. Another natural density informativeness criterion is to use the ratio of labeled data to unlabeled data to encourage collecting data in regions where there is little labeled data relative to unlabeled data. Thus the combined informativeness score of an instance x is defined as:

s_{combined}(x)∝s_{AL}(x)ρ(x) (1)

where an exponent w controls the relative contribution of each factor (e.g., ω=1), S_{AL} (x) is the score given by the AL policy and ρ(x) is the density ratio between the unlabeled and labeled pool.

In regions of the feature space where the labeled pool is not populated or very sparse, p will diverge or become very large. Unless the unlabeled pool is also very sparse, this means that such regions should be given high priority. In a combination algorithm, such regions are prioritized and the combined score is replaced by (ρ(x) is the density in the unlabeled pool):

\tilde{s}_{combined}(x)∝s_{AL}(x)ρ(x)^{ω} (2)

In other words, a process for combining policies includes, in each AL iteration:
1. Separate unlabeled instances in two groups (ρ̅(x) is the density in the labeled pool): i) instances for which the estimated p̅(x)=0, and ii) instances for which p̅(x)≠0,
2. For group i) Prioritize unlabeled pool instances by the score in Eq. (2),
3. For group ii) Prioritize unlabeled pool instances by the score in Eq. (1),
4. Group i) has higher priority than group ii),
5. Select the next batch according to these priorities.

The results with a real world credit card fraud dataset with a large class imbalance show that a three-stage policy (Random+ODAL+Uncertainty) provides a high performance model with as few as 5000 labeled instances collected with low variance guarantees. The ML model benefits from a high level of regularization and PCA feature selection.

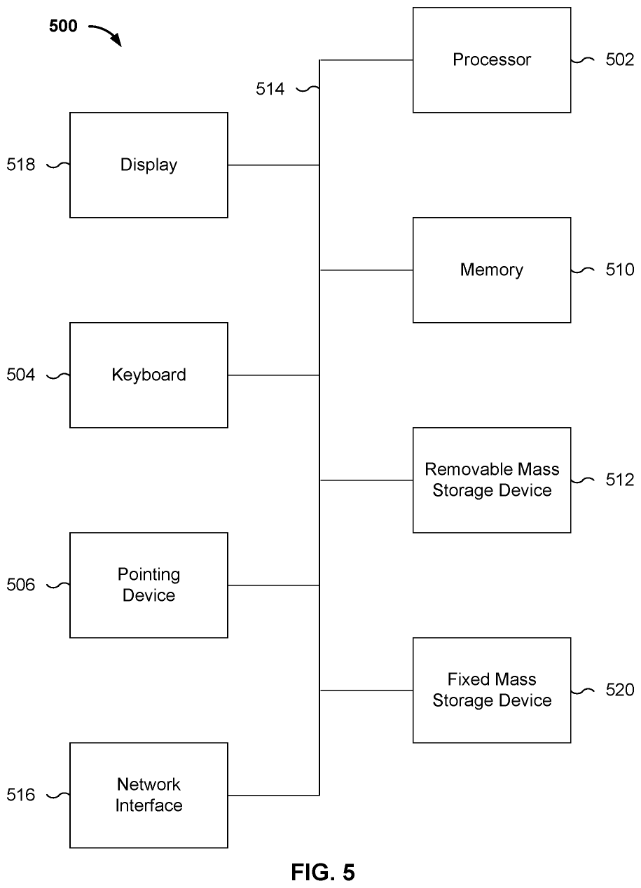

FIG. 5 is a functional diagram illustrating a programmed computer system for providing an active learning annotation system that does not require historical data in accordance with some embodiments. As will be apparent, other computer system architectures and configurations can be used to perform the described active learning annotation technique. Computer system 500, which includes various subsystems as described below, includes at least one microprocessor subsystem (also referred to as a processor or a central processing unit (CPU) 502). For example, processor 502 can be implemented by a single-chip processor or by multiple processors. In some embodiments, processor 502 is a general purpose digital processor that controls the operation of the computer system 500. In some embodiments, processor 502 also includes one or more coprocessors or special purpose processors (e.g., a graphics processor, a network processor, etc.). Using instructions retrieved from memory 510, processor 502 controls the reception and manipulation of input data received on an input device (e.g., pointing device 106, I/O device interface 504), and the output and display of data on output devices (e.g., display 518).

Processor 502 is coupled bi-directionally with memory 510, which can include, for example, one or more random access memories (RAM) and/or one or more read-only memories (ROM). As is well known in the art, memory 510 can be used as a general storage area, a temporary (e.g., scratch pad) memory, and/or a cache memory. Memory 510 can also be used to store input data and processed data, as well as to store programming instructions and data, in the form of data objects and text objects, in addition to other data and instructions for processes operating on processor 502. Also as is well known in the art, memory 510 typically includes basic operating instructions, program code, data, and objects used by the processor 502 to perform its functions (e.g., programmed instructions). For example, memory 510 can include any suitable computer readable storage media described below, depending on whether, for example, data access needs to be bi-directional or uni-directional. For example, processor 502 can also directly and very rapidly retrieve and store frequently needed data in a cache memory included in memory 510.

A removable mass storage device 512 provides additional data storage capacity for the computer system 500, and is optionally coupled either bi-directionally (read/write) or uni-directionally (read only) to processor 502. A fixed mass storage 520 can also, for example, provide additional data storage capacity. For example, storage devices 512 and/or 520 can include computer readable media such as magnetic tape, flash memory, PC-CARDS, portable mass storage devices such as hard drives (e.g., magnetic, optical, or solid state drives), holographic storage devices, and other storage devices. Mass storages 512 and/or 520 generally store additional programming instructions, data, and the like that typically are not in active use by the processor 502. It will be appreciated that the information retained within mass storages 512 and 520 can be incorporated, if needed, in standard fashion as part of memory 510 (e.g., RAM) as virtual memory.

In addition to providing processor 502 access to storage subsystems, bus 514 can be used to provide access to other subsystems and devices as well. As shown, these can include a display 518, a network interface 516, an input/output (I/O) device interface 504, pointing device 506, as well as other subsystems and devices. For example, pointing device 506 can include a camera, a scanner, etc.; 1/0 device interface 504 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 500. Multiple I/O device interfaces can be used in conjunction with computer system 500. The I/O device interface can include general and customized interfaces that allow the processor 502 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 516 allows processor 502 to be coupled to another computer, computer network, or telecommunications network using a network connection as shown. For example, through the network interface 516, the processor 502 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 502 can be used to connect the computer system 500 to an external network and transfer data according to standard protocols. For example, various process embodiments disclosed herein can be executed on processor 502, or can be performed across a network such as the Internet, intranet networks, or local area networks, in conjunction with a remote processor that shares a portion of the processing. Additional mass storage devices (not shown) can also be connected to processor 502 through network interface 516.

In addition, various embodiments disclosed herein further relate to computer storage products with a computer readable medium that includes program code for performing various computer-implemented operations. The computer readable medium includes any data storage device that can store data which can thereafter be read by a computer system. Examples of computer readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system shown in FIG. 5 is but an example of a computer system suitable for use with the various embodiments disclosed herein. Other computer systems suitable for such use can include additional or fewer subsystems. In some computer systems, subsystems can share components (e.g., for touchscreen-based devices such as smart phones, tablets, etc., I/O device interface 504 and display 518 share the touch sensitive screen component, which both detects user inputs and displays outputs to the user). In addition, bus 514 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a stream of unlabeled data;
identifying a portion of the unlabeled data to label without access to label information;
receiving a labeled version of the identified portion of the unlabeled data and storing the labeled version as labeled data; and
analyzing the labeled version and at least a portion of the received unlabeled data that has not been labeled to identify an additional portion of the unlabeled data to label and store in the labeled data including by applying at least one warm up policy.

2. The method of claim 1, wherein when a first event in the stream of unlabeled data is received, no historical data is available.

3. The method of claim 1, further comprising pre-processing at least a portion of the stream of unlabeled data including by at least one of:
applying domain knowledge feature engineering to transform raw fields into at least one is of a numerical feature or categorical feature;
applying automatic feature engineering to generate a feature engineering plan based on semantics of raw fields;
applying unsupervised feature selection to iteratively remove features by computing pairwise correlations on a training set of features; or
applying unsupervised feature selection to map a feature space to a lower dimensional space.

4. The method of claim 1, wherein identifying the portion of the unlabeled data to label includes at least one of: randomly selecting a sample of the unlabeled data to label or performing unsupervised learning on the unlabeled data to select a sample of unlabeled data.

5. The method of claim 4, wherein the warm up policy is an outlier discriminative active learning warmup policy including:
training an outlier detection model on the labeled data;
scoring the unlabeled data using the trained outlier detection model to find the greatest outliers relative to the labeled data; and
labeling the greatest outliers relative to the labeled data.

6. The method of claim 1, wherein identifying the additional portion of the unlabeled data to label includes applying another policy after applying the warm up policy, the other policy being a warm up policy or a hot policy.

7. The method of claim 6, wherein the other policy is applied in response to meeting at least one switching criterion.

8. The method of claim 6, wherein the hot policy includes performing uncertainty sampling.

9. The method of claim 6, wherein at least one of the warmup or hot policies is combined with a density estimate based at least in part on importance sampling ratios.

10. The method of claim 6, wherein at least one of the warmup or hot policies is combined with a density estimate by:
separating unlabeled data into a first group and a second group;
prioritizing unlabeled data in the first group based at least in part on scoring that prioritizes instances by probability density magnitude;
prioritizing unlabeled data in the second group based at least in part on scoring that prioritizes instances by importance sampling ratio magnitude; and
prioritizing the first group over the second group.

11. The method of claim 1, wherein the unlabeled data does not grow in size.

12. The method of claim 1, wherein in a first state, the labeled data includes labeled events.

13. The method of claim 1, further comprising performing supervised training of a machine learning model including by using at least a portion of the labeled data to train the machine learning model.

14. The method of claim 13, wherein performing supervised training of a machine learning model further includes:
splitting data to be processed by the machine learning into one or more Train-Validation pairs to train; and
determining one or more performance metrics of the machine learning model for each pair.

15. The method of claim 14, further comprising, prior to performing the supervised training using the labeled data:
determining that the machine learning model is ready for deployment based on at least one deployment criterion;
wherein the at least one deployment criterion is based at least in part on stabilization of to metrics that are independent of scoring rules.

16. The method of claim 13, further comprising, prior to performing the supervised training using the labeled data:
determining that the machine learning model is ready for deployment based on at least one deployment criterion.

17. The method of claim 16, wherein the at least one deployment criterion is based at least in part on stabilization of metrics that are independent of scoring rules.

18. The method of claim 1, wherein the warm up policy includes an outlier discriminative active learning policy.

19. A system, comprising:
a processor configured to:
receive a stream of unlabeled data;
identify a portion of the unlabeled data to label without access to label information;
receive a labeled version of the identified portion of the unlabeled data and storing the labeled version as labeled data; and
analyze the labeled version and at least a portion of the received unlabeled data that has not been labeled to identify an additional portion of the unlabeled data to label and store in the labeled data including by applying at least one warm up policy; and
a memory coupled to the processor and configured to provide the processor with instructions.

20. A computer program product embodied in a non-transitory computer readable medium and comprising computer instructions for:
receiving a stream of unlabeled data;
identifying a portion of the unlabeled data to label without access to label information;
receiving a labeled version of the identified portion of the unlabeled data and storing the labeled version as labeled data; and
analyzing the labeled version and at least a portion of the received unlabeled data that has not been labeled to identify an additional portion of the unlabeled data to label and store in the labeled data including by applying at least one warm up policy.
